(19) United States
(12) Patent Application Publication
(10) Pub. No.: US 2020/0033697 A1
(43) Pub. Date: Jan. 30, 2020

(54) SLIDABLE WEBCAM CONCEALING APPARATUS

(71) Applicant: Anil Rami, Hilo, HI (US)

(72) Inventor: Anil Rami, Hilo, HI (US)

(21) Appl. No.: 16/047,040

(22) Filed: Jul. 27, 2018

(51) Int. Cl. G03B 11/04; E05D 15/06; G06F 1/16

(52) U.S. Cl. CPC G03B 11/04; E05D 15/0621; E05Y 2900/606; G06F 1/1686; G06F 1/1656

(57) ABSTRACT

The invention discloses an improved design of slim mechanical webcam cover or more specifically, it is a slidable concealing webcam cover for the devices with cameras and webcams such as laptop, smartphone, tablet, Television or any personal digital assistant, etc. to protect the owner of such devices from unauthorized access of their camera by any unknown person without knowledge of the owner, for any reasons such as for stalking, blackmailing or voyeurism etc. The slidable concealing webcam cover comprises a main body having; a holder, a slider and an attachment member. The holder of the concealing cover is divided into two main portions which are holding frame and aperture, wherein the holding frame supports and ensures the displacement of the slider within the aperture allowing it to move only in one direction which is parallel to upper-lower frame, while it locks the movement of the slider in any other direction. The aperture encloses the slider so that slider can run within the length of the aperture only, to cover or uncover the lens of the camera. The permanent attachment member attaches the concealing cover over the surface of the camera from the side support members of the holder frame. Furthermore, the covers get attached over the camera in such a way that the lens of the camera fall beneath the aperture of the concealing cover allowing the slider to cover or uncover it by moving within the aperture.

### FIELD OF THE INVENTION

The present disclosure relates to the field of the webcam/camera obstructing device. More specifically, it is a slidable concealing apparatus for webcam that can be attached over the camera to conceal the lens of the camera while the camera is not in use, to block light from entering through the lens. Hence, eliminating risk of unauthorized surveillance or camfecting by spies.

### BACKGROUND OF THE INVENTION

Mobile phones have quickly become taken as much for granted as electricity or central heating or cooling system. Mobile phones have changed our attitudes and expectations. Same with laptops, desktops, and tablet computers. Laptops are one of the most innovative recent inventions and have greatly impacted how we do things in the 21st Century. These computing systems come equipped with cameras. These cameras can be used for different functions such as taking pictures, recording videos, video conferring and many other. Embedding cameras into electronic devices has become commonplace. But with this commonness comes great question of security.

The available webcam protector cover protects the webcam of mobile phones and laptop with a two supporting rails. Current product includes sliding webcam covers that has two supporting rails which increases the thickness of the cover and that can be easily bumped off. Conventionally, certain products have been developed for protecting webcam for different relation to the mobile device. A fully exposed position exposes both the first camera lens and the at least one sensor of the mobile device. The slidable cover is embedded in the protective case for mobile device and thus, increases the thickness.

Therefore, there exists a need for alternative sliding cover which uses the tight fit between the holding frame and device to be attached to hold the slider in place which can work as a very thin webcam cover which is required by today's thin laptop enclosures and cell phones that is not easily bumped off.

### SUMMARY OF THE INVENTION

This summary is provided to introduce a selection of concept of a simplified form that are further disclosed in the detailed description of the invention. This summary is not intended to identify key or essential inventive concepts of the claimed subject matter, nor is it intended to determine the scope of the claimed subject matter.

The invention, disclosed herein, addresses the above mentioned need for an improved design of slidable concealing apparatus for webcams or cameras of laptop, tablet, smartphone, television or any personal digital assistant, etc. Wherein the concealing apparatus can be attached over the camera in such a way that when the slider of the concealing apparatus is in closed position, it covers the lens of the camera and blocks the light from entering into the lens, hence protects the user of the camera device from being spied by the spooks; even if the webcam or camera of the aforementioned device has been hacked by the spy. Furthermore, the slider of the concealing apparatus can be moved in the opposite direction from the closed position which opens up the lens of the camera when desired, allowing the user to use the camera in traditional way.

The slidable webcam concealing apparatus according to an embodiment of the invention comprises: a holder or rim, a slider and an attachment member. According to one exemplary embodiment, the holder frame or rim of the concealing cover is rounded rectangular rim with a concentric rounded rectangular aperture of slight smaller radius compared to the radius of the rounded rectangular rim, forming a holding frame structure that consist of a parallel upper and lower frame and a pair of side support members, that works as a main frame and hold together all other components of the concealing cover. Furthermore, the rounded rectangular shape of the rim hence the apparatrus is mere exemplary, and without departing from the scope and spirit of the present invention, any geometric shape can be chosen for the apparatus such as rectangular, circular, oval, square or hexagonal, etc. The Slider of the apparatus is a sliding member which covers the lens of the camera when it is not in use, to protect from unauthorized surveillance of the user by any unauthorized person. The slider is square in shape with height same as the height of the aperture, while the width of the slider is half of the width of the aperture which ensures the diagonal movement of the slider parallel to the upper and lower frame, within the length of the aperture and as the width of the slider is half of the aperture, the slider ensures two stationary positions within the aperture. However, the apparatus is fixed over the camera in a way that the lens of the camera sets beneath one stationary position of the slider within the aperture which covers the camera, while the second stationary position uncovers the lens allowing user to use it when desired. Furthermore, the slider consists of a pair of extensions protruding out from the sides which comes in contact with the upper and lower frame of the holder when installed. Said extensions protrudes and installed such a way that when the concealing apparatus attaches over the device, the extension sets between the device and the upper-lower frame of the holder frame which works as a groove for the movement of the slider within the aperture and also prevents the up-down movement of the slider.

Furthermore, the attachment member of the apparatus having double sided adhesive surfaces which attaches over side support members of the holder from one adhesive side, while to the surface of the camera from the outstanding adhesive side, fastening slidable concealing apparatus to the device with web camera. As mentioned, only side support member of the holder attaches to the surface of device using attachment member, while the upper and lower frames according to present embodiment of the invention does not attaches over the surface, causing free space between rear surface of the frames and the surface of the device which works as a guiding groove for the extensions of the slider and prevents the displacement of slider in any other direction except longitudinal to the aperture.

According to present embodiment of the invention, the concealing cover positioned and fastened over the camera in the fashion that the lens of the camera sits beneath any one half of the aperture such that the slider by being moved from one position to another position within the aperture, covers or uncovers the lens of the camera, allowing users to choose as he/she desires.

The main object of the slidable webcam concealing apparatus is to provide mechanical cover the webcams and cameras of the devices such as laptop, tablet, smartphone, television or any personal digital assistant etc to protect the owner of such devices from camfecting.

Further object of the preset invention is to provide slidable webcam concealing apparatus which is simple in construction, rigid in nature even though with its thinnest profile.

The object of the invention is to provide a smoothly slidable concealing apparatus that works on almost all the devices having cameras or webcams.

Yet another object of the present invention is to provide slidable webcam concealing apparatus with an ultrathin profile with a thickness that easily allows perfect closing of the laptop with the slidable concealing cover attached over the webcam, and also suitable for any smartphones even with their protective covers.

Yet another object of the present invention is to provide slidable webcam concealing apparatus in which the slider rests on the device to be attached on, instead of a second rail system that decreases thickness of the concealing apparatus.

### BRIEF DESCRIPTION OF DRAWINGS

Other objects, features and advantages of the present subject matter will be apparent from the following description when read with reference to the accompanying drawings. Drawings are illustrated with different views according to different embodiments of the invention:

FIG. 1 illustrates prospective view of the slidable webcam concealing cover according to an embodiment of the present invention.

FIG. 2 exemplarily illustrates a holding or holder frame of the concealing apparatus according to an embodiment of the present invention.

FIG. 3 exemplarily illustrates an attachment member of the concealing apparatus according to an embodiment of present invention.

FIG. 4 exemplarily illustrates a slider or sliding member of the concealing apparatus according to an embodiment of present invention.

### DETAILED DESCRIPTION

Detailed embodiment of the present invention are disclosed herein; however, it is to be understood that the disclosed embodiments are merely exemplary of the present invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather to provide an understandable description of the invention.

This invention describes the subject matter for patenting with specificity to meet statutory requirements. However, the description itself is not intended to limit the scope of this patent. This principle described herein may be embodied in many different forms.

Illustrative embodiments of the invention now will be described more fully hereinafter with reference to the accompanying drawings in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refers to like elements throughout.

The present invention provides a slidable webcam concealing apparatus that protects user from unauthorized access and surveillance of user from their own devices with webcams or cameras such as laptop, tablet, smart phone, or any personal digital assistant etc., without knowledge of the user. The webcam concealing apparatus does not protect the camera of the device from being hacked but it protects the user from being spied even if the camera of his device has been hacked by providing a slidable concealing apparatus which covers the lens of the camera when it is not in use preventing the light to enter into the lens of the camera that in turn protects user from being spied for any reason, even if the camera has been hacked.

This mechanical concealing apparatus according to one embodiment of the invention sits and affixes over the surface of the camera of any of the above mentioned device in a way that the lens of the camera fall beneath the aperture of the apparatus, wherein the aperture according to an embodiment of the invention comprises a slider sliding within the aperture such that one of its position within the aperture covers the lens while another location of it uncovers it to be used when required.

According to one exemplary embodiment of the present invention the slidable webcam concealing apparatus comprises: a holder rim or a holding frame which further comprises a parallel upper and lower frame, side support members and an aperture all of these together forms a main frame of the concealing apparatus that holds together all other components of the apparatus. The upper-lower frame, a side support member and an aperture of the apparatus are made as a single unit that forms a frame of the apparatus. Further, the concealing apparatus comprises a sliding member or a slider enclosed within the aperture of the holder, sized such that the aperture frames the slider from the upper and lower members of frame allowing it to run longitudinally within the aperture or simply the height of the slider is same as the height of the aperture while the length of the slider is half of it so that the slider can easily fit within the aperture and can run only in one direction which is longitudinal to the aperture. According to an embodiment of the present invention, the slider of the apparatus further comprises an extensions protruding from the sides which interacts with the upper and lower frame members of the holding rim. Said extensions according to an embodiment of the inventions sets beneath the upper-lower frame members of the holding frame, when the slider gets installed within the aperture of the holder. Further, when the user fastens the concealing apparatus over the surface of the camera, the extensions takes place between the surface of the device to be attached and the upper-lower frame members of the holding frame that in turn held together the slider within the aperture and locks its up-down displacement. The space between the upper-lower frame members of the holding frame and the surface of the device to be attached works as a groove in which the extensions of the slider takes place due to the construction of the apparatus and this groove allows smooth movement of the slider within the aperture while preventing and locking its movements in any other direction.

Moreover, the slidable webcam concealing apparatus according to an embodiment of the present invention further comprises and attachment members that fastens and holds the concealing apparatus over the surface of the device. The attachment member is any of the double sided adhesive tape, such as but not limited to, double sided 3M tape, sized same as the side support members of the holding frame to attach the side support members of the holding frame only, with the surface of the device, creating space between the upper-lower frame members of the holding frame and the surface of the device to be attached. Said created space between the upper-tower frame and the surface of the device due to construction of the apparatus in this way and due to the attachment members which attaches the apparatus from the side support members of the frame only, works as a groove for the extensions of the slider which holds the slider within the apparatus and also locks and controls its movement within the aperture.

According to one embodiment of the invention, the slidable webcam concealing apparatus are made and not limited to any of the material such as metals like Aluminum, Stainless steel, Copper, alloys of metals or polymer, carbon fiber, etc. The frame and the slider are made of same material or both can be made of different mentioned material which are merely exemplary and without departing from meaning and scope of the present invention any of the material which allows rigidness and toughness even though the thinness of components can be used for their preparation.

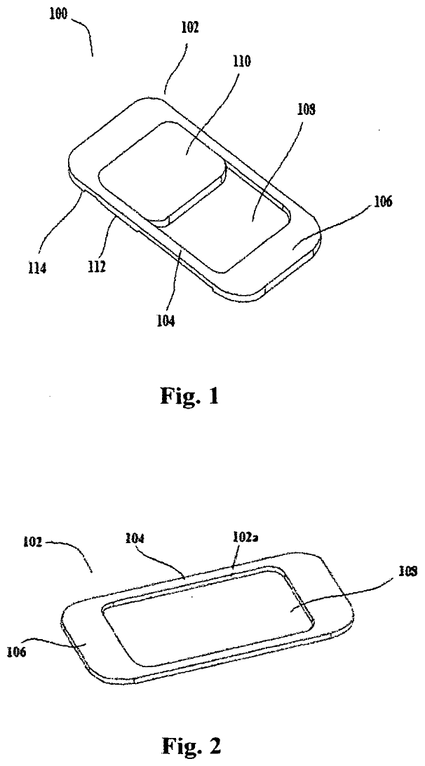

Now, FIG. 1 exemplarily illustrates prospective view of the slidable webcam concealing apparatus 100 according to one embodiment of the present invention which can be attached over the surface of the camera of any of the user device such as, but not limited to, the laptop, smartphone, tablet, desktop computer or any personal digital assistant etc. to protect the user from the camfecting. The slidable webcam concealing cover 100 comprises a holding frame 102 made as a single unit and can be divided into three components for better understanding of the present invention. Said holding frame is made of a parallel upper and lower frame members 104, a side support member 106 and an aperture 108. According to present exemplary embodiment of the invention, the shape of the holding frame 102 is rounded rectangular and the shape of the aperture 108 is also rounded rectangular with smaller dimensions compared to the holding frame 102 which forms a set of parallel support members which are upper-lower frame members 104 and a side support members 106.

Further, the concealing apparatus 100 according to present embodiment of the invention comprises a sliding member or a slider 110 having an extensions 112 protruding out from the sides of the slider 100 that interact with the upper-lower frame member 104 of the holding frame 102. The slider is sized such that it fits within the aperture 108 of the holding frame 102 and can slide diagonally within the length of the aperture 108 allowing user to cover or uncover the lens of the camera when the apparatus 100 is installed over the surface of the camera. While the extensions 112 protrudes from the slide 110 such that when installed within the aperture 108, the extensions 112 sets below the upper-lower 104 of the holding frame 102 which locks and holds the slider within the aperture 108 of the holding frame 102 when the concealing apparatus 100 is installed or attached over the surface of the device.

Furthermore, the concealing cover 100 comprises an attachment member 114 that attaches the concealing apparatus 100 over the surface of the camera to be attached on. The attachment member 114 is more preferably, but not limited to, the unconventional foam tape such as double sided 3M tape that adhere on the side support members 106 of the holding frame 102 of the concealing cover 100 from one adhesive side and to the surface of the camera to be attached on from the other side. The adhesion side of the attachment member 114 from where it get attached to the surface of the device to be attached further comprises a removable backing (not shown), releasibly attached over it to protect the adhesive surface of the attachment member 114 from dust till its attachment over the surface of the camera of any of the abovementioned devices.

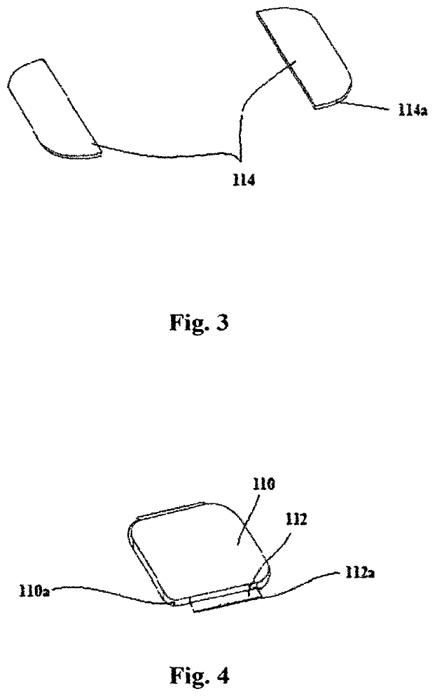

FIG. 2 exemplarily illustrates a holding or holder frame 102 of the concealing apparatus 100 according to an embodiment of the present invention. It shows holder frame 102 of the concealing apparatus 100 having a parallel upper and lower frame members 104, a pair of side support members 106 and an aperture 108. According to one embodiment of the invention the width 102a of the holding frame 102 is approximately 0.2 mm which is equal all around the perimeter of the holding frame 102. FIG. 3 exemplarily illustrates an attachment member 114 of the concealing apparatus 100 according to an embodiment of the present invention where the attachment members 114 attaches to the side support members 106 of the holding frame 102 from one adhesive side and to the surface of the device to be attached from the other side thus leaves an space of equal width as the attachment member 114 beneath the upper-lower frame members 104 of the holding frame 102 when attached over the surface of the device being attached on. According to present embodiment of the invention the width 114a of the attachment member 114 is chosen approximately 0.1 mm making total width of the concealing apparatus 100 to approximately 0.3 mm. FIG. 4 exemplarily illustrates a slider or sliding member 110 of the concealing apparatus 100 according to an embodiment of present invention where the total width 110a of the sliding member 110 is also selected approx. 0.3 mm with the extensions 112 protruding out from two opposite sides of the slider 110 from near the base portion of the of the sides of the slider 110, while the width 112a of the extensions 112 is almost same as the width 114a of the attachment member 114 of FIG. 2 thus when all three components, the holder 102, the slider 110 and the attachment member 114 of the concealing cover 100 get installed together and attached over the surface of the device to be attached on, the attachment member 114 creates the room of the same width as the width 114a of an attachment members 114 between the upper-lower frame members 104 and the surface of the device being attached on. While the slider 110 fits within the aperture 108 of the holding frame 102 with the extensions 114 enclosed in the abovementioned space or room as the width of the space, attachment member 114 and the extensions 112 are same. This room or space encloses the extension 112 and works as a groove for the movement of the slider 110 within the aperture 108. According to an embodiment of the present invention, the holding frame 102 and the slider 110 are made of the material such as, but not limited to, any of the metal or polymers or a combination thereof.

1. The Slidable webcam concealing apparatus for protection from camfecting comprising of:
a) A main body or holding frame having a parallel upper and lower frame members, a side support members and an aperture;
b) A sliding member or slider; and
c) An attachment member.

2. The slidable webcam concealing apparatus of claim 1, wherein the holding frame is made as a single unit.

3. The slidable webcam concealing apparatus of claim 1, wherein the aperture encloses the slider from two sides when installed together allowing it to run longitudinally within the length of the aperture.

4. The slidable webcam concealing apparatus of claim 1, wherein the slider further comprises a pair of extensions protruding from two opposite sides of the slider.

5. The slidable webcam concealing apparatus of claim 4, wherein the two opposite sides of the slider are sides that interacts with the upper-lower frame members of the holding frame.

6. The slidable webcam concealing apparatus of claim 4, wherein the extensions fits beneath the upper-lower frame members when the slider is installed together with the holder over the surface of the device.

7. The slidable webcam concealing apparatus of claim 1, wherein the side support members of the holding frame fastens over the surface of the device to be attached using attachment members.

8. The slidable webcam concealing apparatus of claim 1, wherein the attachment member creates free space or room of same width as attachment member between the parallel upper-lower support frames and the surface of the device being attached on when the apparatus is installed over the device.

9. The slidable webcam concealing apparatus of claim 1, wherein the space between the upper-lower frame members and the surface of the device works as a guiding groove for the movement of the extensions within the space when the slider installed together with the holder over the surface of the camera of device to be attached.

10. The slidable webcam concealing apparatus of claim 1, wherein the height of the slider is same as the height of the aperture while length is half of length of aperture so that the slider can acquire to stationary positions within the length of the aperture that covers and uncovers the lens of the camera.

11. The slidable webcam concealing apparatus of claim 1, wherein the apparatus is made of a metal from the group consisting of Aluminum, Copper, Stainless Steel, metal alloys or a combination thereof.

12. The slidable webcam concealing apparatus of claim 1, wherein the apparatus is made of a polymer material or a carbon fiber.

13. The slidable webcam concealing apparatus of claim 1, wherein the width of the apparatus is 0.3 mm.

14. The webcam shield according to claim 1, wherein the attachment member is any of double sided unconventional foam tape.

15. The slidable webcam concealing apparatus of claim 1, wherein the device for the apparatus to be attached on is any of the laptop, smartphone, tablet or any personal digital assistant.
